(19) United States
(12) Patent Application Publication
(10) Pub. No.: US 2019/0248691 A1
(43) Pub. Date: Aug. 15, 2019

(54) SYSTEM AND METHOD FOR OPTIMIZATION OF AN ION EXCHANGE SYSTEM

(71) Applicant: KURION, INC., Irvine, CA (US)

(72) Inventors: Joshua MERTZ, Irvine, CA (US); Ja-Kael LUEY, Irvine, CA (US)

(21) Appl. No.: 16/333,415

(22) PCT Filed: Sep. 13, 2017
(86) PCT No.: PCT/US2017/051404

§ 371 Date: Mar. 14, 2019

Related U.S. Application Data
(60) Provisional application No. 62/395,278, filed on Sep. 15, 2016.

(51) Int. Cl. C02F 9/00; C02F 1/42; G21F 9/12; G21F 5/14; C02F 1/28; C02F 1/00

(52) U.S. Cl. CPC C02F 9/00; C02F 1/42; G21F 9/12; G21F 5/14; C02F 2101/006; C02F 1/001; C02F 2303/16; C02F 2301/04; C02F 1/28

(57) ABSTRACT

Systems and methods are disclosed for utilizing lead-tag configuration with ion exchange systems to increase process efficiency, increase media utilization, and reduce system downtime.

This application claims priority to U.S. Provisional Patent Application Ser. No. 62/395,278; entitled: METHOD FOR OPTIMIZATION Of ION EXCHANGE SYSTEMS; filed Sep. 15, 2016 which is herein incorporated by reference in its entirety.

### COPYRIGHT NOTICE

Contained herein is material that is subject to copyright protection. The copyright owner has no objection to the facsimile reproduction by anyone of the patent document or the patent disclosure, as it appears in the United States Patent and Trademark Office patent file or records, but otherwise reserves ail rights to the copyright whatsoever. The following notice applies to the software, screenshots and data as described below and in the drawings hereto and All Rights Reserved.

### TECHNICAL FIELD

This disclosure relates generally to systems and methods for the physical removal of insoluble species from liquids.

### BACKGROUND

Water treatment is crucial for large and small scale industrial project wastewater including nuclear waste water, contaminated water resulting from oil and gas production, and contaminated liquids from other industrial endeavors. Some water treatment methods include filtration and ion exchange. Both methods often utilize a lead/lag processing approach. A lead/lag configuration utilizes at least two ion exchange vessels or filters in series. In an example using two ion exchange vessels, one vessel is the lead vessel and one is the lag vessel. The lead vessel performs most, or all, of the work exchanging ions with the process liquid while the lag vessel is in line to protect against premature leakage or exhaustion of the lead vessel.

When the lead vessel reaches a predetermined level of breakthrough leakage, or has reached capacity (i.e. no longer capable of sorbing contaminants), it can be taken offline for servicing. When the lead vessel is serviced it becomes the lag vessel and the former lag vessel becomes the lead vessel. With the current state of the art, these lead-lag systems are not interchangeable and the flow of material is generally stopped when the lead is in need of servicing.

What is needed are systems and methods for continuous flow water treatment utilizing lead-lag configurations with ion exchange systems to increase process efficiency, increase media utilization, and reduce system downtime.

So as to reduce the complexity and length of the Detailed Specification, Applicant(s) herein expressly incorporate(s) by reference all of the following materials identified in each paragraph below. The incorporated materials are not necessarily “prior art” and Applicant(s) expressly reserve(s) the right to swear behind any of the incorporated materials.

Ion Specific Media Removal from Vessel for Vitrification, Ser. No. 15/012,101 filed Feb. 1, 2016. with a priority date of Feb. 1, 2015, which is herein incorporated by reference in its entirety.

Mobile Processing System for Hazardous and Radioactive Isotope Removal, Ser. No. 14/748,535 filed Jun. 24, 2015, with a priority date of Jun. 24, 2014, which is herein incorporated by reference in its entirety.

Applicant(s) believe(s) that the material incorporated above is “non-essential” in accordance with 37 CFR 1.57, because it is referred to for purposes of indicating the background or illustrating the state of the art. However, if the Examiner believes that any of the above-incorporated material constitutes “essential material” within the meaning of 37 CFR 1.57(c)(1)-(3), applicants) will amend the specification to expressly recite the essential material that is incorporated by reference as allowed by the applicable rules.

Aspects and applications presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly stale otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112, ¶ 6. Thus, the use of the words “function,” “means” or “step” in the Detailed Description or Description of the Drawings or claims is not intended to somehow indicate a desire to invoke the special provisions of 35 U.S.C. § 112, ¶ 6, to define the systems, methods, processes, and/or apparatuses disclosed herein. To the contrary, if the provisions of 35 U.S.C. § 112, ¶ 6 are sought to be invoked to define the embodiments, the claims will specifically and expressly state the exact phrases “means for” or “step for, and will also recite the word “function” (i.e., will state “means for performing the function of . . . ”), without also reciting in such phrases any structure, material or act in support of the function. Thus, even when the claims recite a “means for performing the function of . . .” or “step for performing the function of . . .”, if the claims also recite any structure, material or acts in support of that means or step, or that perform the recited function, then it is the clear intention of the inventors not to invoke the provisions of 35 U.S.C. § 112, ¶ 6. Moreover, even if the provisions of 35 U.S.C. § 112, ¶ 6 are invoked to define the claimed embodiments, it is intended that the embodiments not be limited only to the specific structure, material or acts that are described in the preferred embodiments, but in addition, include any and all structures, materials or acts that perform the claimed function as described in alternative embodiments or forms, or that are well known present or later-developed, equivalent structures, material or acts for performing the claimed function.

### BRIEF DESCRIPTION OF THE DRAWINGS

A more complete understanding of the systems, methods, processes, and/or apparatuses disclosed herein may be derived by referring to the detailed description when considered in connection with the following illustrative figures. In the figures, like-reference numbers refer to like-elements or acts throughout the figures.

FIG. 1 depicts an exemplary skid embodiment comprising three ion specific media (ISM) vessels.

FIG. 2 depicts two skids connected such that they may be operated in parallel and/or in series.

FIG. 3 depicts an initial flow configuration where process flow is directed through Skid A first then through Skid B.

FIG. 4 depicts the configuration of FIG. 3 when all three vessels in Skid A are partially loaded.

FIG. 5 depicts the configuration of FIG. 3 when the first vessel in Skid A has reached capacity.

FIG. 6 depicts the configuration of FIG. 3 when the first two vessels in Skid A have reached capacity.

FIG. 7 depicts a configuration where all three vessels in Skid A have reached capacity and flow has been rerouted through Skid B, isolating Skid A for servicing.

FIG. 8 depicts the configuration of FIG. 7 where a first vessel in Skid A has been serviced.

FIG. 9 depicts the configuration of FIG. 7 when the first two vessels in Skid A have been serviced and a first vessel in Skid B is partially loaded.

FIG. 10 depicts the configuration of FIG. 7 when all vessels in Skid A have been serviced and all vessels in Skid B are partially loaded.

FIG. 11 depicts a configuration wherein process flow is directed first through Skid A and then through Skid B where all vessels in Skid B are partially loaded.

FIG. 12 depicts the configuration of FIG. 11 where the first two vessels in Skid B are at capacity.

FIG. 13 depicts a configuration wherein all vessels in Skid B are at capacity and process flow is directed through Skid A, isolating Skid B for servicing.

FIG. 14 depicts the configuration of FIG. 13 when a first vessel in Skid B has been serviced.

FIG. 15 depicts the configuration of FIG. 13 when the first two vessels in Skid B have been serviced and a first vessel in Skid A is partially loaded.

FIG. 16 depicts the configuration of FIG. 13 when all vessels in Skid A have been serviced and all vessels in Skid B are partially loaded.

FIG. 17 depicts a configuration when all vessels in Skid B have been serviced and Skid B is brought back online following Skid A in the process flow.

FIG. 18 depicts an exemplary lead-lag configuration for two ISM vessels.

FIG. 19 depicts an exemplary lead-lag-polish system comprising three ISM vessels at three different times in operation.

FIG. 20 depicts an exemplary lead-lag-polish with standby system comprising four ISM vessels at four different times in operation.

Elements and acts in the figures are illustrated for simplicity and have not necessarily been rendered according to any particular sequence or embodiment.

### DESCRIPTION

In the following description, and for the purposes of explanation, numerous specific details, process durations, and/or specific formula values are set forth in order to provide a thorough understanding of the various aspects of exemplary embodiments. It will be understood, however, by those skilled in the relevant arts, that the apparatus, systems, and methods herein may be practiced without these specific details, process durations, and/or specific formula values. It is to be understood that other embodiments may be utilized and structural and functional changes may be made without departing from the scope of the apparatus, systems, and methods herein. In other instances, known structures and devices are shown or discussed more generally in order to avoid obscuring the exemplary embodiments. In many cases, a description of the operation is sufficient to enable one to implement the various forms, particularly when the operation is to be implemented in software. It should be noted that there are many different and alternative configurations, devices, and technologies to which the disclosed embodiments may be applied. The full scope of the embodiments is not limited to the examples that are described below.

In the following examples of the illustrated embodiments, references are made to the accompanying drawings which form a part hereof, and in which is shown by way of illustration various embodiments in which the systems, methods, processes, and or apparatuses disclosed herein may be practiced. It is to be understood that other embodiments may be utilized and structural and functional changes may be made without departing from the scope.

The following disclosure relates to continuous operation of ion exchange systems. Ion exchange vessels are used to separate particular ions from a liquid waste stream. In operation, ion exchange media in ion exchange vessels sorbs contaminants and becomes loaded. When ion exchange media is fully loaded it can no longer sorb additional contaminants and is therefore no longer effective (i.e. it is at capacity). In order to run a continuous operation multiple vessels are needed. In some embodiments, two or more vessels are cycled such that one or more fully loaded vessels may be replaced whilst one or more operational vessels remain in operation. The term “operational” refers to vessels that have not yet reached capacity and are capable of sorbing additional contaminants.

Systems and methods ore disclosed herein for continuous ion separation from liquids using ion exchange systems. Uninterrupted liquid processing allows for increased efficiency and reduced costs. Further, the disclosed systems and methods maximize usage of ion exchange media while balancing other considerations. For example, for radioactive applications, the systems and methods disclosed herein may allow one or more of full utilization of ion exchange media with the limitation for shielding and full utilization of ion exchange media with consideration for decay heat.

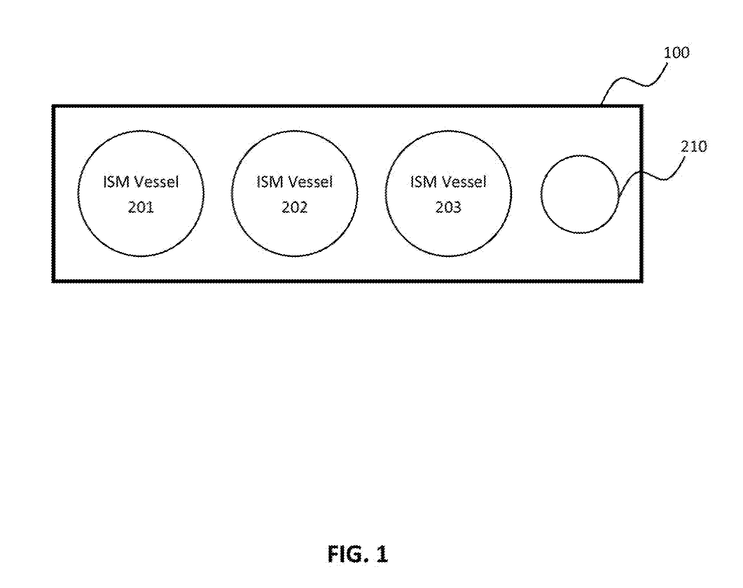

In some embodiments, one or more ion exchange vessels (also referred to as ion-specific media, or ISM, vessels) may be contained in a skid, or module, such as those disclosed in Mobile Processing System for Hazardous and Radioactive Isotope Removal, Ser. No. 14/748,535 filed Jun. 24, 2015, which is herein incorporated by reference in its entirety. Each skid may comprise one or more ISM vessels. In some embodiments, such as the embodiment depicted in FIG. 1, each skid 100 comprises three ISM vessels 201, 202, and 203. In some embodiments, a skid 100 may comprise a fourth position 210, or an additional ISM vessel. Having more than one ISM vessel enables change in the flow path and allow removal of the lead ISM vessel while enabling continued operation. The number of vessels used in each system may depend on media optimization given mass transfer zone predictions. In some embodiments, two or more skids 100 may be connected such that they may be operated in parallel and/or in series depending on how flow is directed through the system. In some embodiments, two or more ISM vessels may be run in parallel lines within one or more skids.

The performance of ISM is a function of space velocity (residence time) and linear velocity, which are both functions of the processing rate. The size of the ISM vessels may vary to optimize performance of the ISM for specific applications, inputs, flow rates, and effluent requirements. In some embodiments, one or more vessels may be aligned in one or more skids wherein each vessel is used to capacity before the flow is routed through a next vessel (referred to herein as a “merry-go-round” effect). In some embodiments, one or more vessels may be allowed to operate freely wherein each skid comprising one or more vessels may be operated as if it is a single vessel. In the depicted embodiments described herein, each skid comprises three vessels and operates freely as if it is a single vessel.

For the sake of clarity, the systems and methods are described herein with reference to the skid embodiment depicted in FIG. 1. However, it should be clear that the systems and methods may be applied to other ion exchange vessel configurations including skids containing more or fewer vessels, other mobile configurations, and other fixed configurations not explicitly disclosed or depicted herein. In the depicted configurations, valves 110 are closed, valves 115 are open, flow path 120 is unused (depicted as thin lines), and process flow 125 is the current process flow path (depicted as thick lines) for each depicted configuration. The valves 110 and 115 are exemplary only to indicate open and closed flow paths 120 and 125. More or fewer valves 110 and 115 may be incorporated at varying locations in the system.

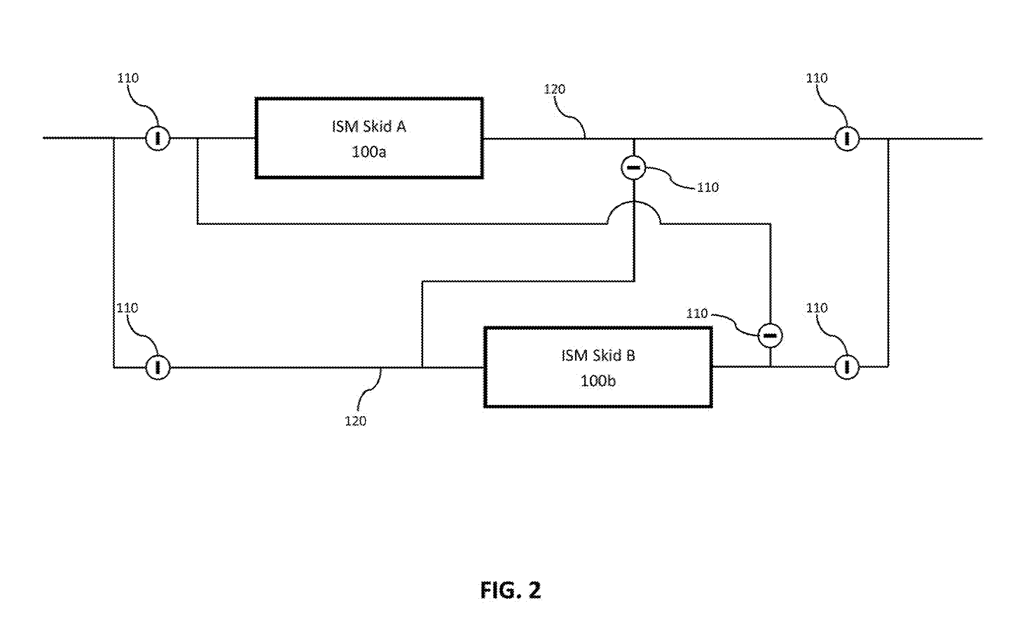

FIG. 2 depicts two skids 100a,b connected such that they may be operated in parallel and/or in series depending on how flow is directed. One or more valves 110 may be situated between the skids 100a,b such that flow may be directed as needed. In the depicted embodiments, the valves 110 are closed when the line is perpendicular to the flow path 120 and open when the line is parallel to the flow path 120. In the depicted embodiment, the system is inactive, the flow path 120 is closed off, and all of the valves 110 are closed. The one or more valves 110 may be any of one or more types as appropriate for the volume or mass flow rate, control types, safety, and other considerations based on their location in the system. In some embodiments, one or more of the valves 110 may be motor operated such that they may be controlled remotely.

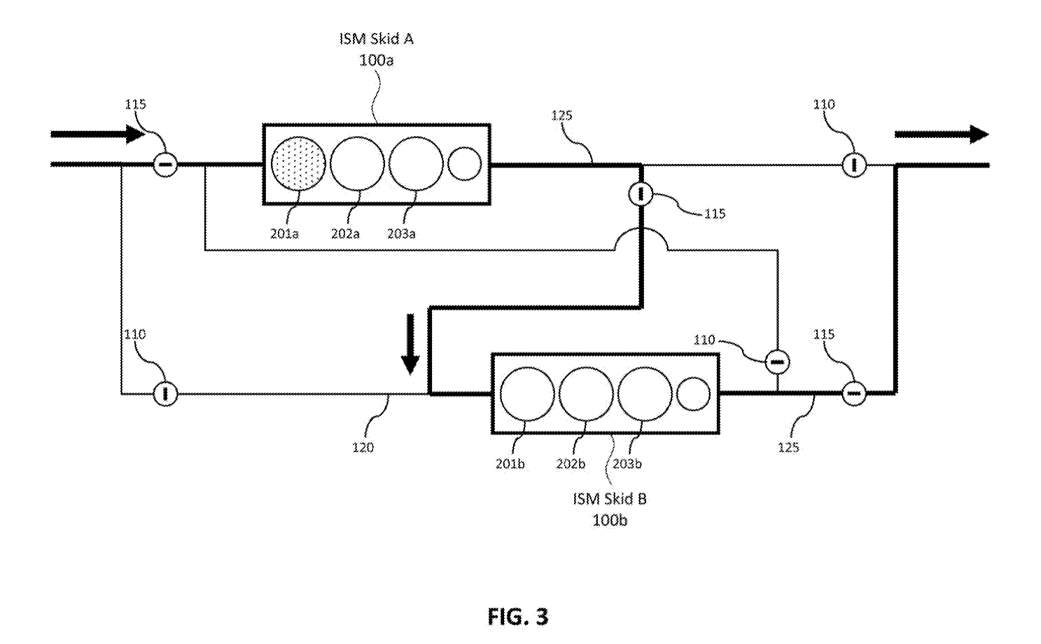

FIG. 3 depicts an initial flow configuration where process flow 125 is directed through Skid A 100a first then through Skid B 100b. The first skid in series is referred to herein as the “lead” skid and the second skid is referred to herein as the “lag” skid. The corresponding systems and methods are referred to herein as “lead-lag”. The ISM vessels 201a. 202a. and 203a in Skid A 100a sorb the contaminants from the process flow 125 at a faster rate than the ISM vessels 201b, 202b, and 203b in Skid B 100b. This occurs because the process flow 125 will contain fewer contaminants as it progresses through the process. In FIG. 3 the first ISM vessel 201a is partially loaded.

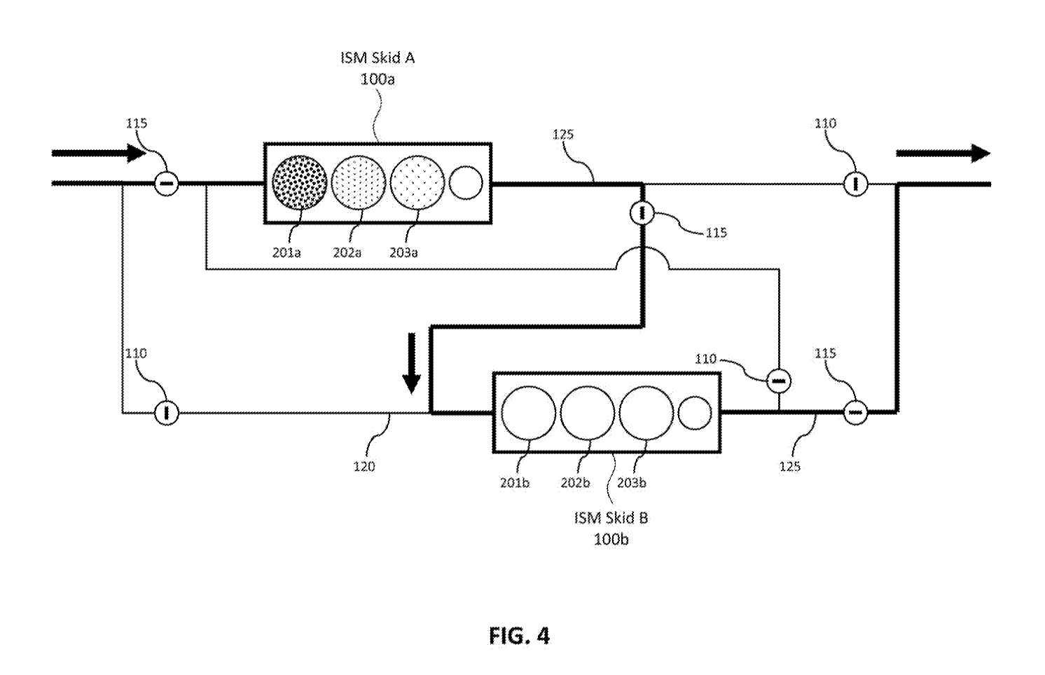

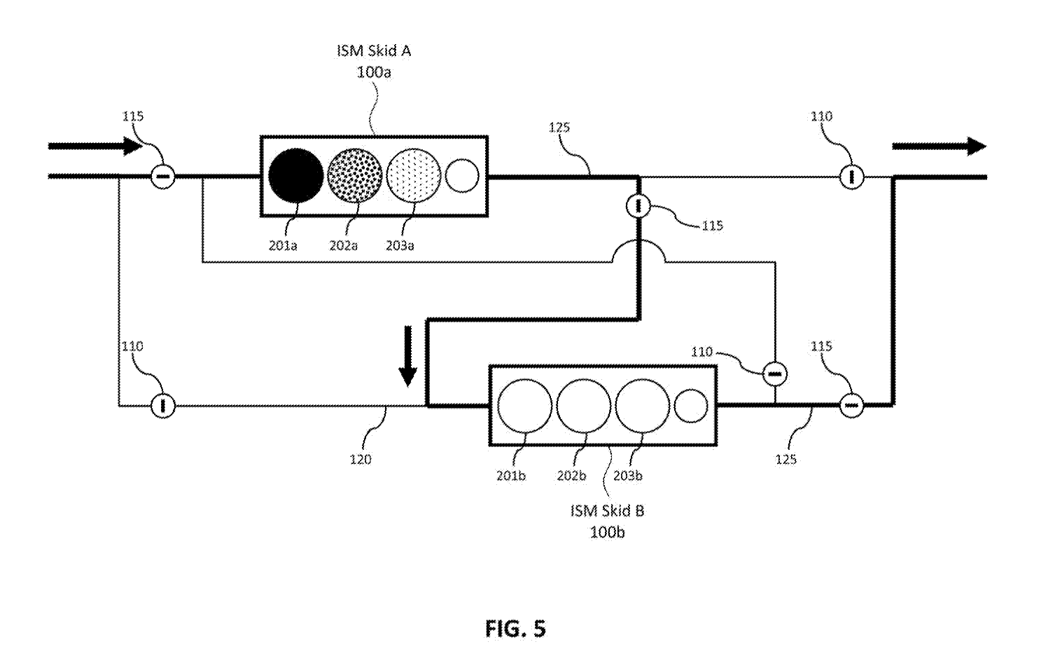

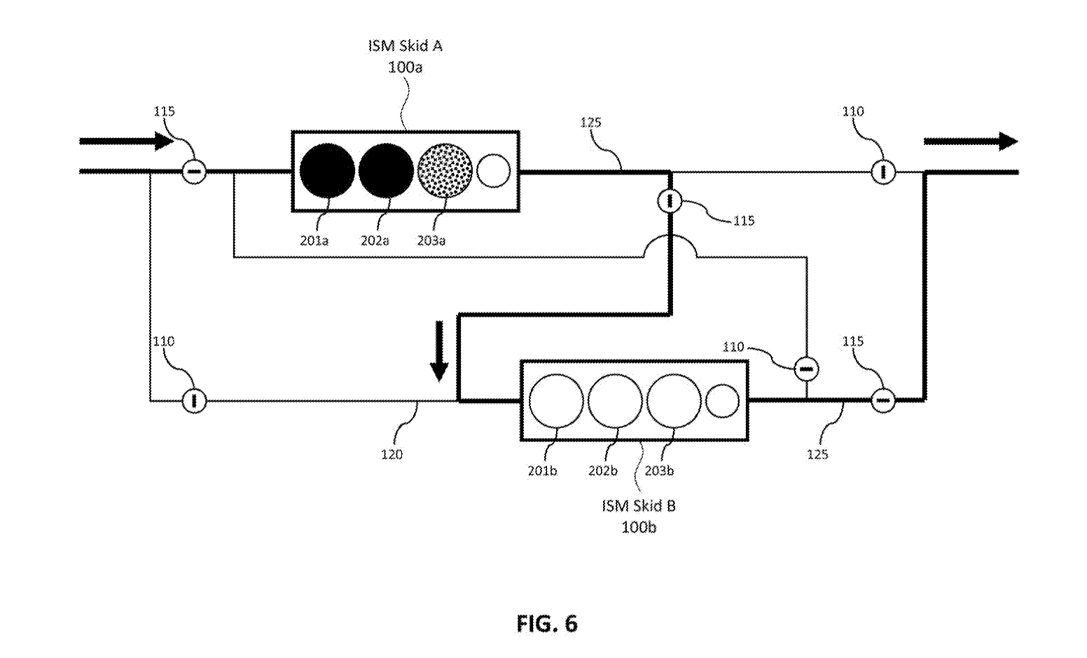

FIGS. 4 through 6 depict the configuration of FIG. 3 over a period of time. As time progresses the ISM vessels 201a, 202a, and 203a in Skid A 100a continue to sorb contaminants and reach capacity, or some other predetermined limit. For the sake of clarity, a vessel ready for servicing will be described as being “at capacity” for the remainder of the disclosure relating to the depicted process embodiment; however, it should be clear that vessels may be ready for servicing based on a number of other factors and/or predetermined limits. The predetermined limit may be based on a breakthrough percentage, effluent criteria, and/or other factors. In FIG. 4 all three vessels 201a, 202a, and 203a in Skid A 100a are partially loaded. The first vessel 201a is closer to capacity than the second vessel 202a which is closer to capacity than the third vessel 203a. In FIG. 5 the first vessel 201a has reached capacity. The second vessel 202a begins to load more quickly until it reaches capacity as depicted in FIG. 6.

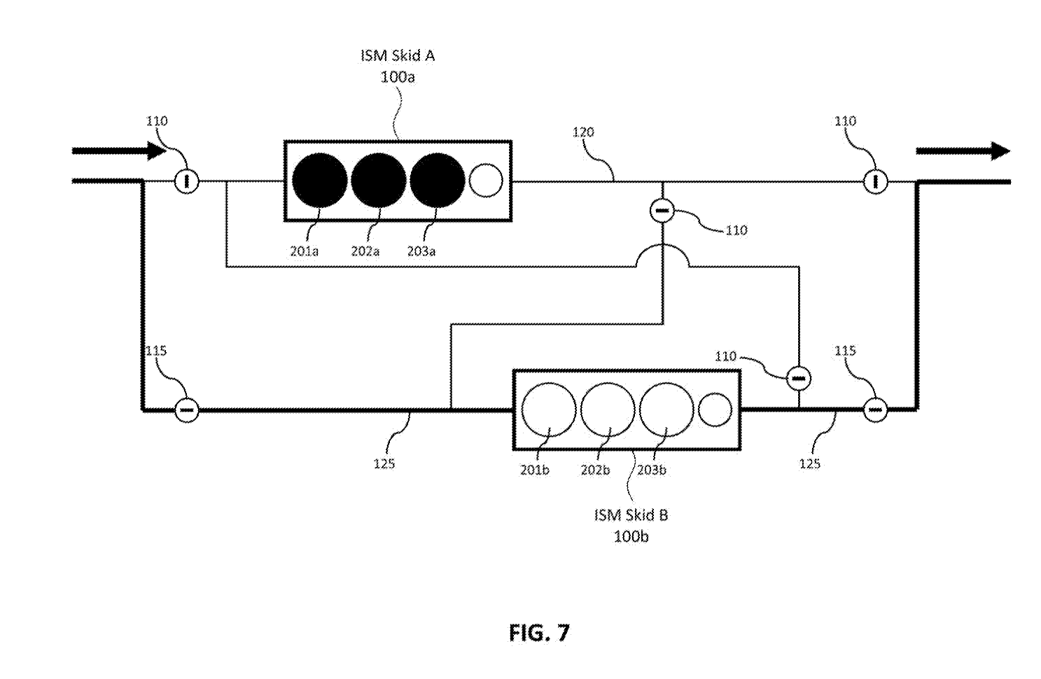

In FIG. 7 all of the vessels 201a. 202a, and 203a in Skid A 100a have reached capacity. Skid A 100a is no longer able to sorb contaminants and the vessels 201a, 202a. and 203a need lo be serviced. Process flow 125 is rerouted to proceed through Skid B 100b only while Skid A 100a is isolated and taken off-line for servicing. Skid B 100b becomes the lead skid and begins to sorb contaminants at a higher rate. In some embodiments, this step takes place around 90 days after process initiation. The process time may vary significantly depending on how many vessels are used, the size and capacity of the vessels, target ions, target effluent specifications, flow rate, temperature, and other variations in the process.

There are several options for how a skid nay be serviced. One option is to regenerate the media in place without removing the vessels from the skid. Another option is to remove the vessels from the skid and replace them with new vessels. In this option the vessels may be serviced separately at the same or another location. Another option is to remove the media from the vessels and replace it with fresh media while the vessels remain in place. Both wet and dry media removal operations are described in co-pending application Ion Specific Media Removal from Vessel for Vitrification, Ser. No. 15/012,101 filed Feb. 1, 2016, with a priority date of Feb. 1, 2015. which is herein incorporated by reference in its entirety.

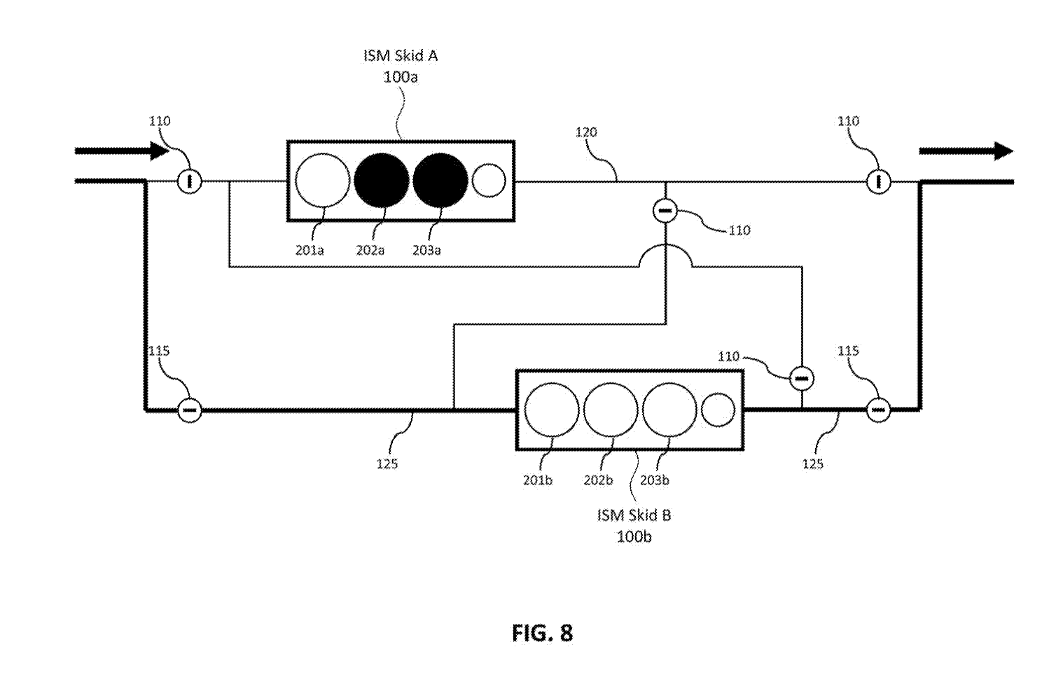

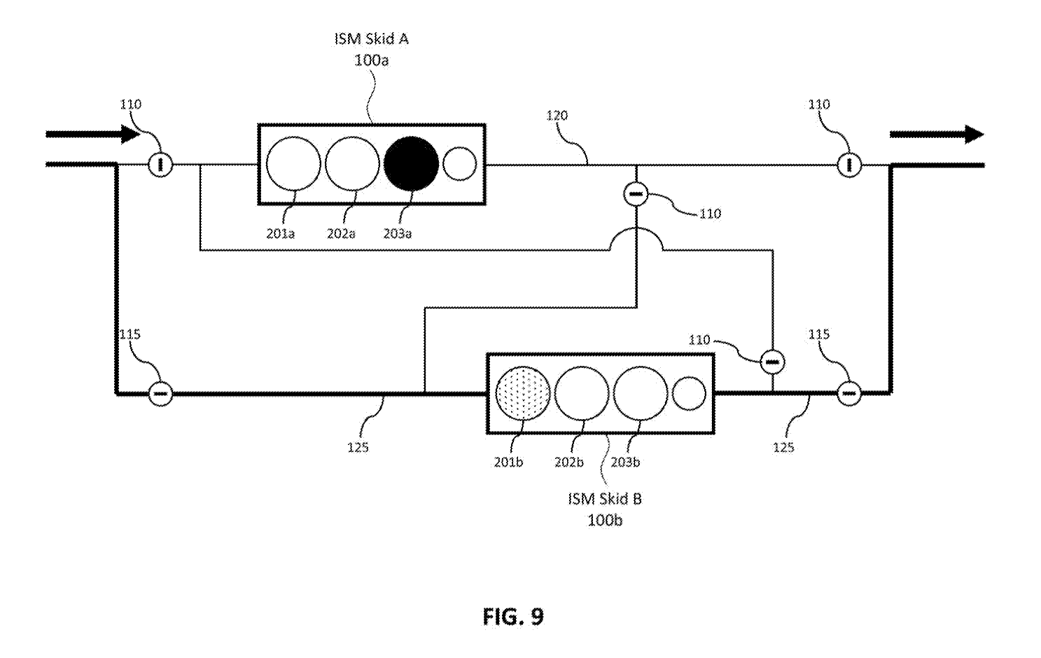

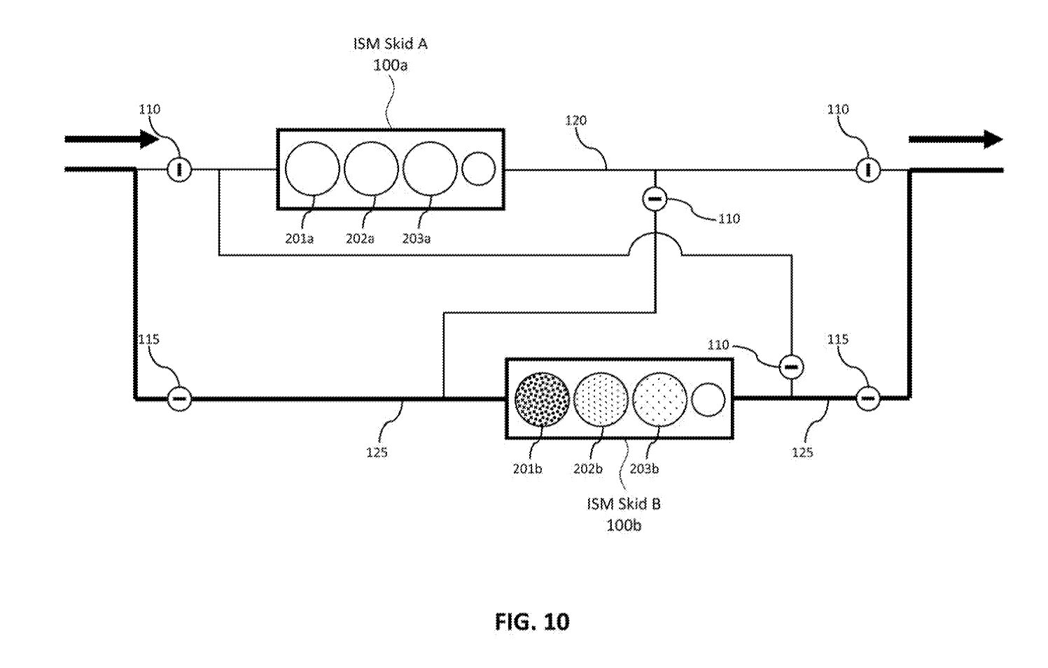

FIGS. 8 through 10 depict an embodiment of the configuration of FIG. 7 over a period of time. The process flow 125 proceeds through Skid B 100b while Skid A 100a is being serviced. As time progresses, vessels 201b. 202b, and 203b in Skid B 100b will sorb contaminants and become more and more loaded. In FIG. 8, process flow 125 has been directed through Skid B 100b and a first vessel 201a in Skid A 100a has been serviced, in an example embodiment. In FIG. 9, an embodiment is shown where vessel 202a has been serviced and vessel 201b is partially loaded. In FIG. 10, the vessels 201b, 202b, and 203b in Skid it 100b are all partially loaded and all vessels 201a, 202a. and 203a in Skid A 100a have been serviced, in an embodiment. To reiterate, the preceding descriptions of FIGS. 8-10 are merely embodiments, and it should be clear that different order and time configurations are possible.

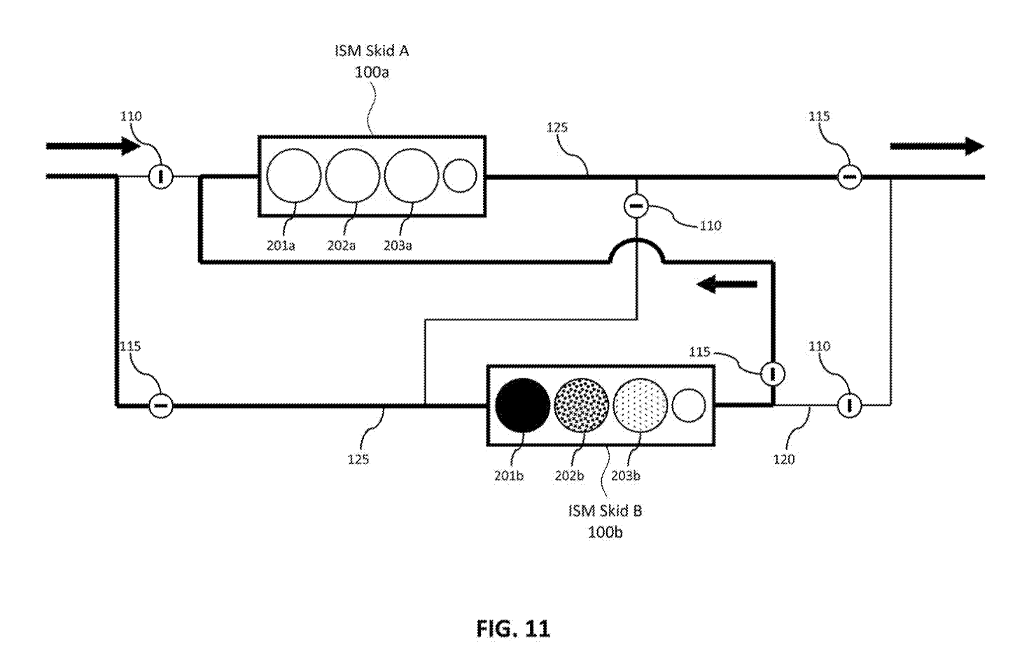

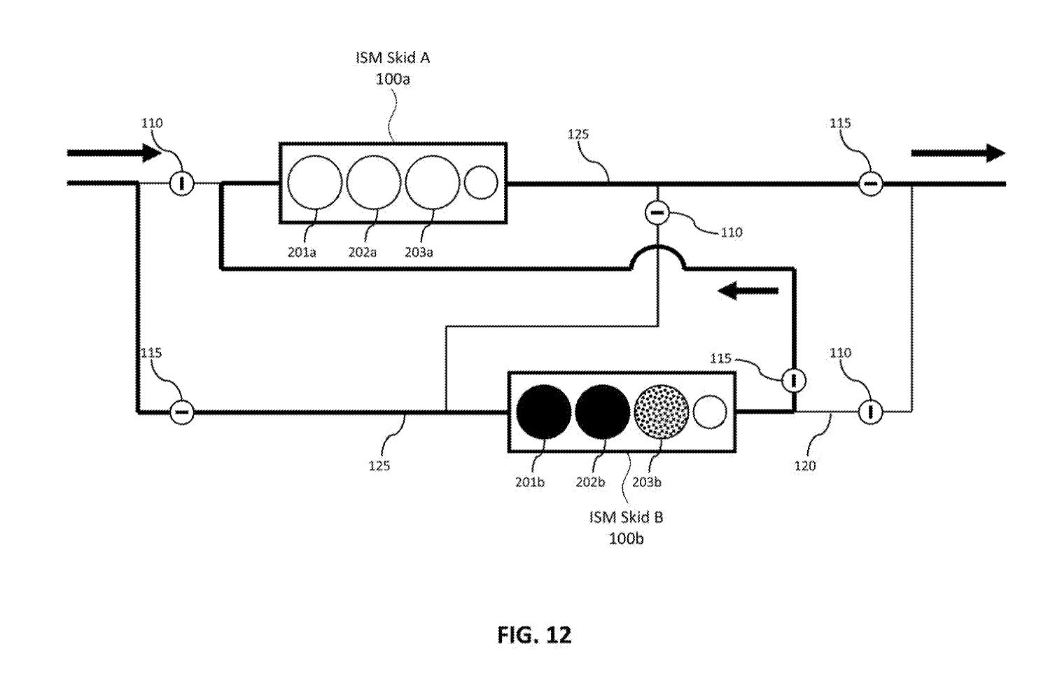

In FIG. 11 all vessels 201a, 202a, and 203a in Skid A 100a have been serviced and process flow 125 has been routed back through Skid A 100a where Skid B 100b remains the lead skid and Skid A 100a becomes the lag skid. The vessels in the lead skid will sorb contaminants at a higher rate than the vessels in the lag skid. In some embodiments, this step takes place around 120 days after process initiation. The process time may vary significantly depending on how many vessels are used, the size and capacity of the vessels, target ions, target effluent specifications, flow rate, temperature, and other variations in the process. In FIG. 12 the vessels 201b, 202b. and 203b in Skid B 100b are near capacity.

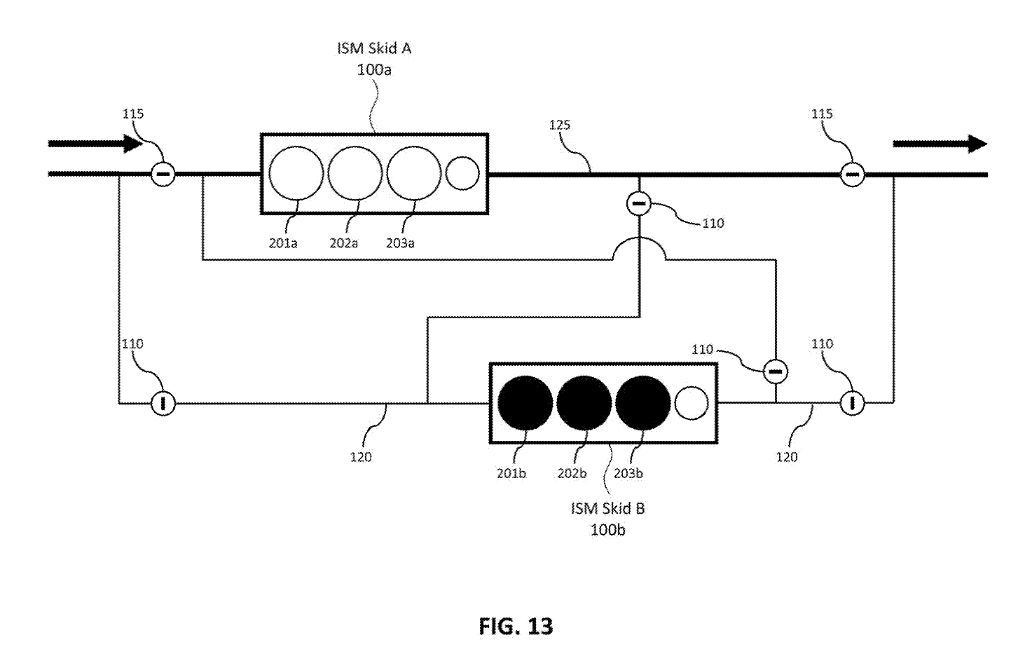

When the vessels 201b, 202b, and 203b n Skid B 100b have reached capacity the process flow 125 will be redirected such that it proceeds through Skid A 100a, isolating Skid B 100b, as depicted in FIG. 13. Skid A 100a becomes the lead skid and Skid B 100b is offline for servicing. Servicing for Skid B 100b may be carried out using one or more of the same systems and methods disclosed for Skid A 100a.

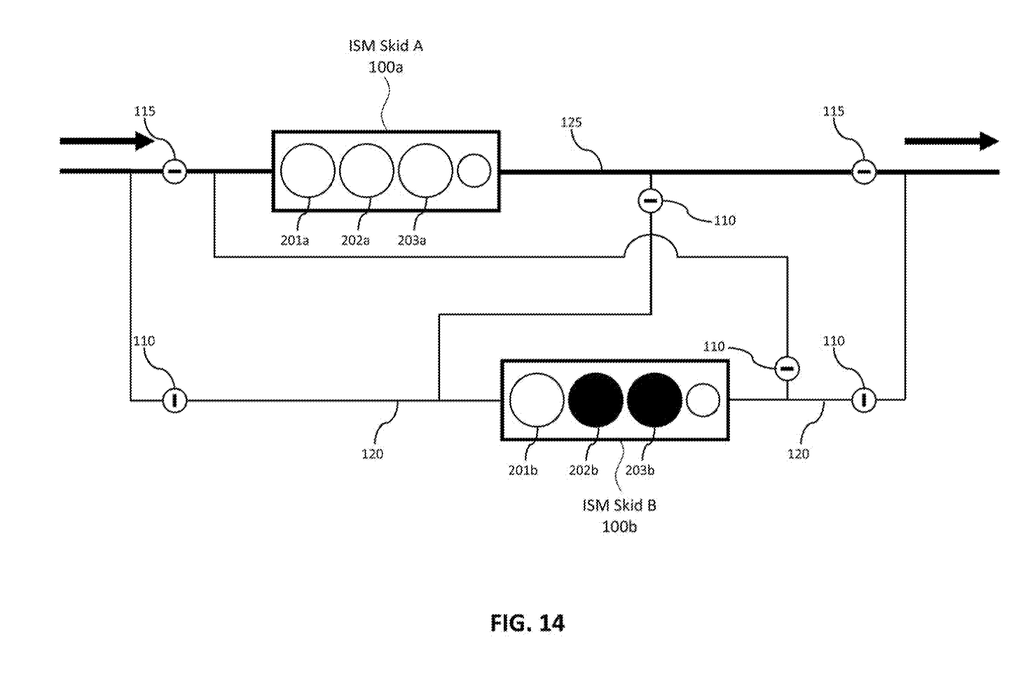

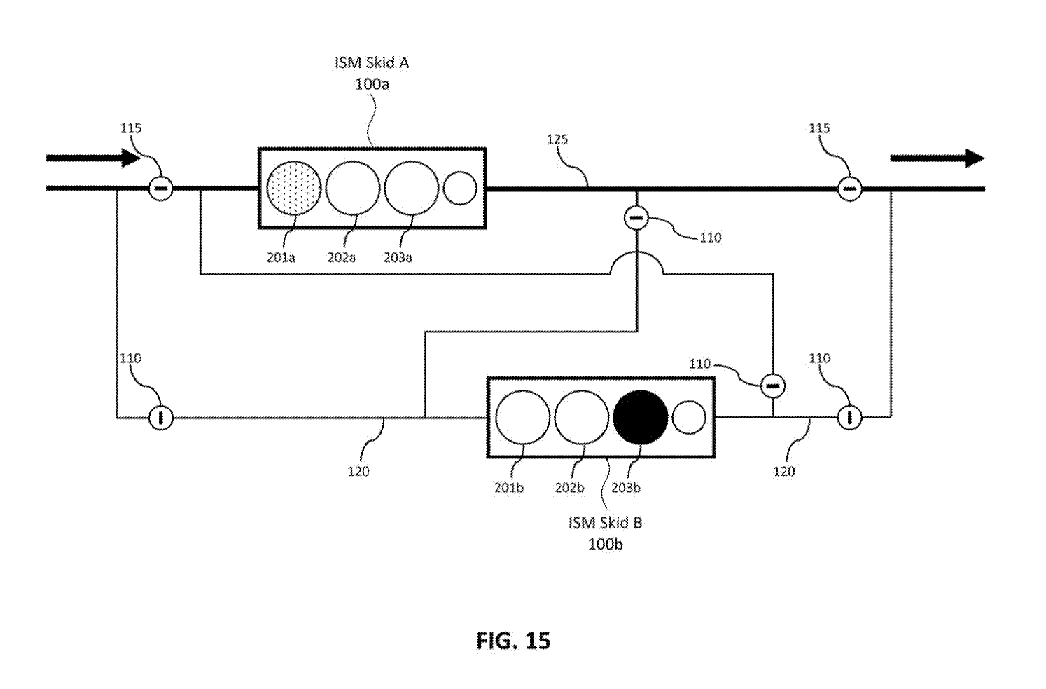

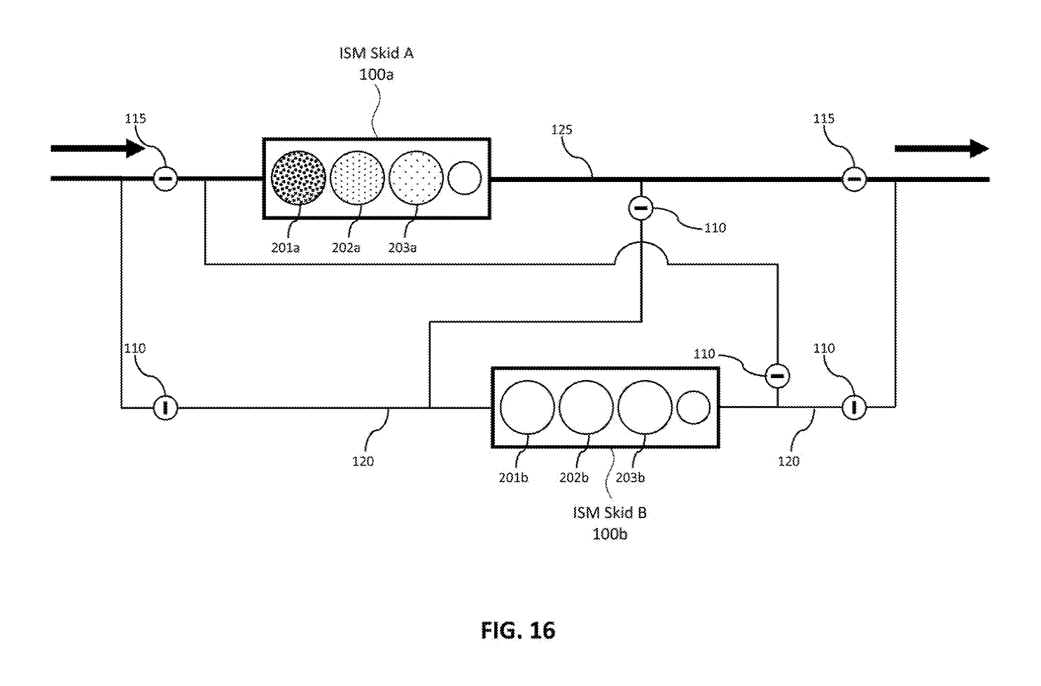

FIGS. 14 through 16 depict the configuration of FIG. 13 over a period of time. The process flow 125 proceeds through Skid A 100a while Skid B 100b is being serviced. As time progresses, vessels 201a, 202a, and 203a in Skid A 100a will sorb contaminants and become more and more loaded. In FIG. 14, process flow 125 has been directed through Skid A 100a and a first vessel 201b in Skid B 100b has been serviced. In FIG. 15, vessel 202b has been serviced and vessel 201a is partially loaded. In FIG. 16, the vessels 201a. 202a, and 203a in Skid A 100a are all partially loaded and all vessels 201b, 202b, and 203b in Skid B 100b have been serviced The preceding descriptions of FIGS. 14-16 are merely possible embodiments, and it should be clear that different order and time configurations are possible.

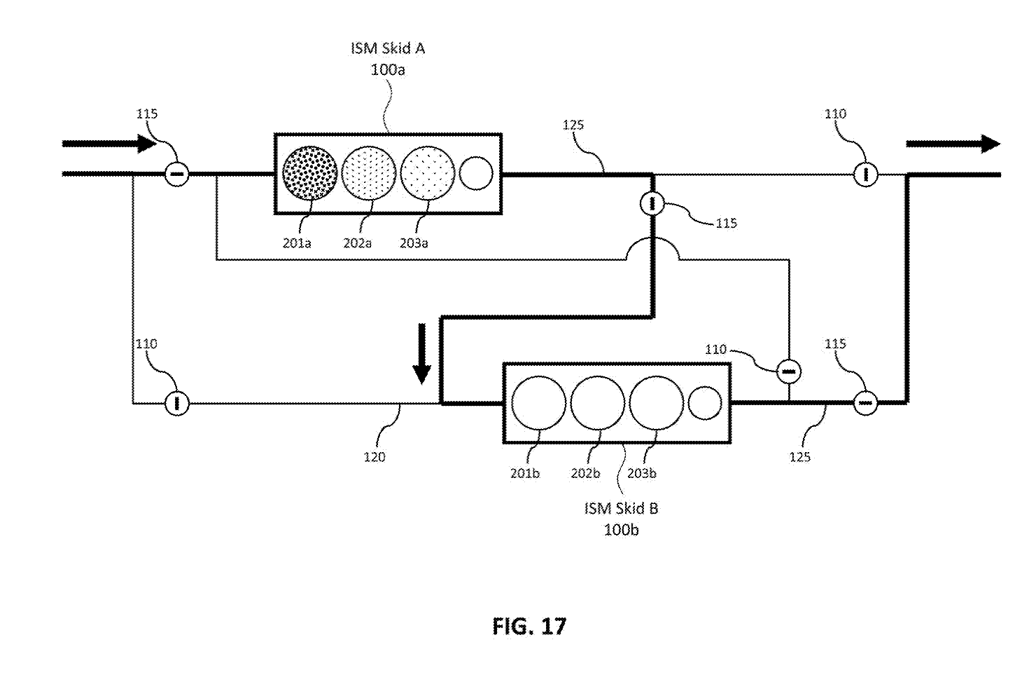

Once the vessels 201b, 202b, and 203b in Skid B 100b have been serviced. Skid B 100b may be brought online and process flow 125 may directed through it as the lag skid, as depicted in FIG. 17. The process may repeat from thereon. In some embodiments, the system may be operated continuously.

In some embodiments, one or more sensors may be incorporated at one or more locations in the system. The sensors may be used to monitor various processing, flow, and environment conditions including ion concentrations, flow rates, pressure, temperature, time, and radiation levels, among others. In some embodiments, the ion concentration of the process flow may be monitored, such as before and after each vessel and/or skid. Some, or all, of the sensor data may be used by a control system to provide an operator with warnings, alarms, and/or suggestions regarding control of the system. In some embodiments, sensor data may be used to automatically cause system responses including rerouting process flow, adjust for varying influent process flow chemistry, shut-down, and environmental controls. Sensor data may be used to determine if the effluent leaving the system meets target specifications.

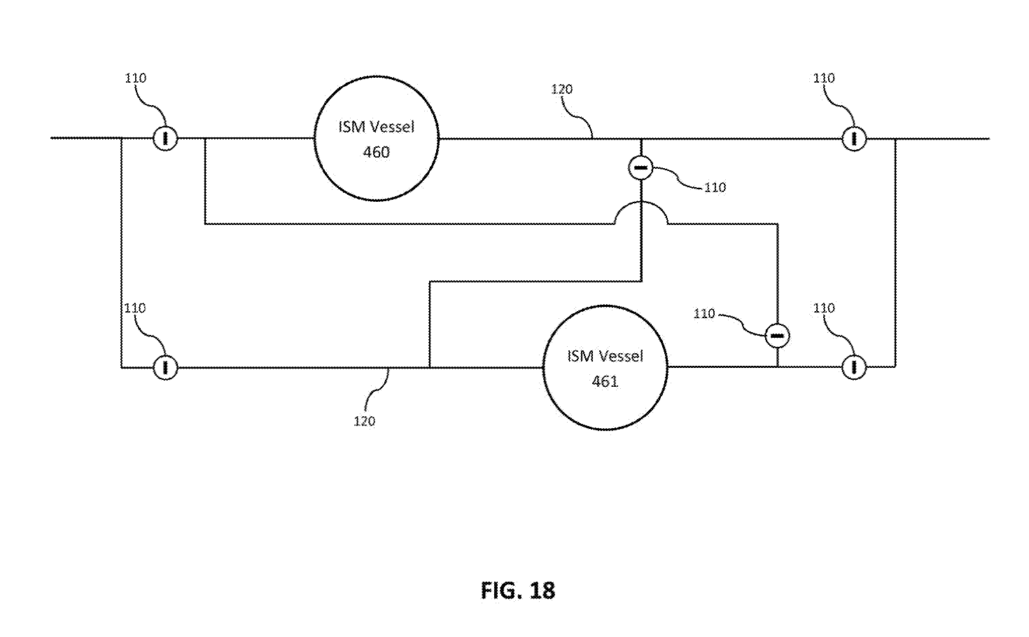

In some embodiments, two or more vessels may be collocated in a skid. In some embodiments, two or more ISM vessels may operate in a lead-lag, lead-lag-polish, or lead-lag-polish with standby configuration. A lead tag configuration for ISM vessels 460, 461, such as the exemplary embodiment depicted in FIG. 18, operates in the same manner as discussed above for skids.

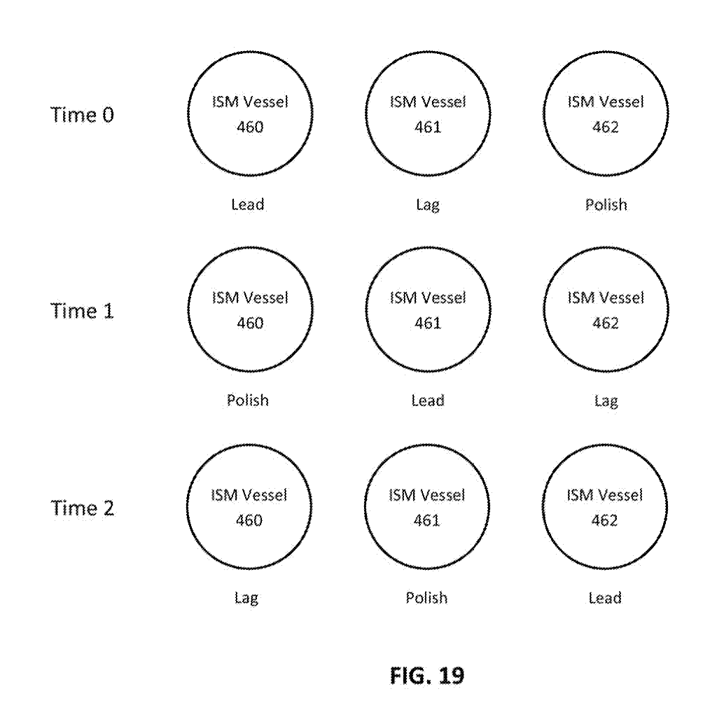

A lead-lag-polish configuration operates much the same as a lead-lag configuration with an additional vessel that can be circulated in as a lag vessel when the lead vessel is taken offline for servicing. The vessels in a lead-lag-polish configuration revolve through the roles of lead, lag, and polish, as depicted in FIG. 19. At time 0, vessel 460 is the lead, vessel 461 is the lag, and vessel 462 is the polish vessel. At time 1, vessel 460 has reached capacity, been serviced or replaced, and has become the polish vessel while vessel 461 has become the lead vessel and vessel 462 has become the lag vessel. At time 2, vessel 461 has reached capacity, been serviced or replaced, and has become the polish vessel while vessel 462 has become the lead vessel and vessel 460 has become the lag vessel. The process may operate continuously, in some embodiments.

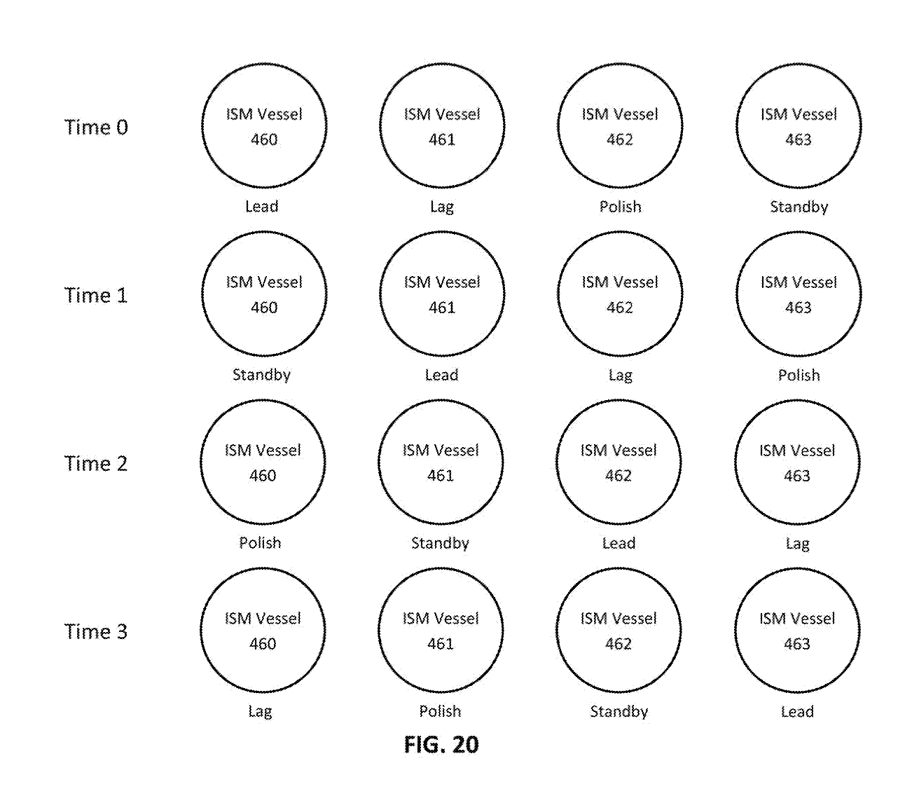

A lead-lag-polish with standby configuration operates in a similar manner to lead-lag-polish with the addition of one or more standby vessels. This configuration allows for limited downtime by putting the standby vessel in line as the polish vessel while the former lead vessel is undergoing servicing. When the vessel being serviced is ready it comes back online as the new standby vessel. In the embodiment depicted in FIG. 20 four ISM vessels are used wherein one is a lead, one is lag, one is polish, and one is standby. At time 0, vessel 460 is the lead, vessel 461 is the lag, vessel 462 is polish, and vessel 463 is the standby vessel. At time 1, vessel 460 has reached capacity, been serviced or replaced, and has become the standby vessel while vessel 461 has become the lead vessel, vessel 462 has become the lag vessel, and vessel 463 has become the polish vessel. At time 2, vessel 461 has reached capacity, been serviced or replaced, and has become the standby vessel while vessel 462 has become the lead vessel, vessel 463 has become the lag vessel, and vessel 460 has become the polish vessel. At time 3, vessel 462 has reached capacity, been serviced or replaced, and has become the standby vessel while vessel 463 has become the lead vessel, vessel 460 has become the lag vessel, and vessel 461 has become the polish vessel. The process may operate continuously, in some embodiments.

Lead-lag, lead-lag-polish, and lead-lag-polish with standby configurations may be applied to ISM vessels and/or ISM skids.

### Mobile Processing System Embodiments

The mobile processing system (MPS) is a mobile liquid processing system that may comprise one or more forms of liquid processing. The MPS is designed to be both transported and operated from standard sized intermodal containers or custom designed enclosures, referred to herein as skids or modules, for increased mobility between sites and on-site, further increasing the speed and case with which the system may be deployed. The skids may be connected in parallel and/or in series in order to perform all of the remediation requirements for any given site.

Depending on the needs of the particular site, one or more different processes may be used. In some embodiments, one or more of the same modules may be used in the same operation. For instance, two or more separate ion specific media (ISM) modules may be used in series and/or in parallel. In some embodiments two or more ISM modules may be operated according to the lead/lag concept described above standalone or as part of an MPS. Other configuration variations not expressly disclosed herein may be implemented.

Further descriptions may be found in US Patent Application entitled Mobile Processing System for Hazardous and Radioactive Isotope Removal, Ser. No. 14/748,535 filed Jun. 24, 2015, with a priority date of Jun. 24, 2014, which is incorporated by reference in a preceding paragraph of this disclosure.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or described features can be implemented by themselves, or in combination with other operations in either hardware or software.

Having described and illustrated the principles of the systems, methods, processes, and/or apparatuses disclosed herein in a preferred embodiment thereof, it should be apparent that the systems, methods, processes, and/or apparatuses may be modified in arrangement and detail without departing from such principles.

1. A system for continuous treatment of process liquid, comprising:
a plurality of modular skids each configured to be transported between sites, the plurality of modular skids connectable in parallel or series configurations, and comprising
a first modular skid having a first ion exchange system comprising one or more ion exchange vessels; and
a second modular skid having a second ion exchange system comprising one or more ion exchange vessels;
wherein the system is operatively configured to perform the method of:
receiving process liquid in the first ion exchange system in a lead position, wherein the first ion exchange system sorbs contaminants from the process liquid resulting in reduced contaminated process liquid,
receiving decontaminated in the second ion exchange system in a lag position, removing the first ion exchange system from the system for servicing when the one or more ion exchange vessels contained therein have reached a predetermined sorb limit,
receiving process liquid in the second ion exchange system wherein the second ion exchange system is in the lead position, wherein the second ion exchange system sorbs contaminants from the process liquid resulting in reduced contaminated process liquid,
reintroducing the first ion exchange system in a lag position,
receiving the reduced contaminated process liquid in the first ion exchange system,
removing the second ion exchange system from roe system for servicing when the one or more ion exchange vessels contained therein have reached a predetermined sorb limit,
receiving process liquid in the first ton exchange system wherein the first ion exchange system is in the lead position and sorbs contaminants from the process liquid resulting in reduced contaminated process liquid,
reintroducing the second ion exchange system in a lag position.
